(19) United States
(12) Patent Application Publication
(10) Pub. No.: US 2019/0034121 A1
(43) Pub. Date: Jan. 31, 2019

(54) INFORMATION PROCESSING APPARATUS, METHOD AND NON-TRANSITORY COMPUTER-READABLE STORAGE MEDIUM

(71) Applicant: FUJITSU LIMITED, Kawasaki-shi (JP)

(72) Inventor: Shinya KUWAMURA, Kawasaki (JP)

(73) Assignee: FUJITSU LIMITED, Kawasaki-shi (JP)

(21) Appl. No.: 16/027,419

(22) Filed: Jul. 5, 2018

(30) Foreign Application Priority Data
Jul. 26, 2017 (JP) 2017-144882

(51) Int. Cl. G06F 3/06

(52) U.S. Cl. CPC G06F 3/0659; G06F 3/068; G06F 3/0604

(57) ABSTRACT

An information processing apparatus includes a processor configured to perform a data storage process for a first storage area in which the element data having mutually different attributes and included in a row of a matrix are arranged, when a state of the element data stored in the first storage area satisfies a certain condition, specify a column in which the element data having a same attribute are included, and store the element data, read, from the first storage area, the element data having a first attribute, perform a first calculation for the first attribute by using the read element data, read, from the second storage area, the element data included in a column and having the first attribute, perform a second calculation for the first attribute by using the read element data, and perform a calculation process by using a results of the first calculation and the second calculation.

### CROSS-REFERENCE TO RELATED APPLICATION

This application is based upon and claims the benefit of priority of the prior Japanese Patent Application No. 2017-144882, filed on Jul. 26, 2017, the entire contents of which are incorporated herein by reference.

### FIELD

The embodiments discussed herein are related to an information processing apparatus, a method and a non-transitory computer-readable storage medium.

### BACKGROUND

Recently, instead of moving data to a central processing unit (CPU) and calculating it, a calculation method referred to as near data processing is attracting attention in which calculation is performed in the vicinity of the data and the performed result is sent to the CPU. By introducing the near data processing, it is possible to reduce a data migration cost and speed up a system.

Here, a case where a solid state drive (SSD) as a storage device storing data is used will be described. The SSD includes a flash memory as a storage medium, and includes a flash memory controller as a control mechanism for performing reading from and writing to the flash memory.

Furthermore, in the SSD, an SSD in the related art including hardware for performing wear leveling and garbage collection and a software-defined SSD for performing the wear leveling and the garbage collection by software are present. The SSD in the related art includes a processor and a dynamic random access memory (DRAM) which control performance of the wear leveling and the garbage collection in the flash memory controller. On the other hand, in the software-defined SSD, for example, an application performed by the CPU manages physical information and controls the performance of the wear leveling and the garbage collection.

In the SSD in the related art, the flash memory controller has an independent processor and the DRAM, and the processor manages the storage of data. Therefore, it is hard to store data in the flash memory in consideration of the efficiency of reading and writing data by the application. On the other hand, in the software-defined SSD, since the CPU performs management of storage locations of data or the like, it is possible to perform efficient data storage by distributed arrangement of data in the flash memory and the like, and it is possible to perform a high-speed process that realizes high throughput and low latency.

In a case of introducing the above-described near data processing to the SSD, in the SSD in the related art, it is possible to perform calculation by using existing processor and DRAM in the flash memory controller. On the other hand, in the software-defined SSD, a calculation circuit for the near data processing is disposed between a flash memory interface (IF) and a host IF in the flash memory controller. In this case, when reading and writing data, as the related art, data transfer is performed between the flash memory IF and the host IF. Meanwhile, when performing the calculation, data read from the flash memory is sent to the calculation circuit, the calculation circuit performs the calculation, and a calculation result is transferred to the CPU via the host IF.

As a technology using the flash memory, there is a related art in which when writing and when reading, data is temporally stored in a local memory, ECC codes in vertical and horizontal directions are added to write data and the added result is stored in the flash memory. In addition, there is a related art in which an additional error correction code is temporally stored in a volatile memory, the written data is stored in the flash memory, the additional error correction code is erased in a case of satisfying a condition. As the related art, there are Japanese Laid-open Patent Publication No. 2013-205853 and Japanese Laid-open Patent Publication No. 2014-182834.

### SUMMARY

According to an aspect of the invention, an information processing apparatus configured to control a storage device including a first storage area and a second storage area configured to store element data forming a matrix, the information processing apparatus includes a memory, and a processor coupled to the memory and configured to perform a data storage process for the first storage area in which the element data having mutually different attributes and included in a row of the matrix are arranged successively, when the data storage process is performed to a plurality of rows respectively and when a state of the element data stored in the first storage area satisfies a certain condition, specify, in the first storage area, a column in which the element data having a same attribute are included, store the element data included in the column in the second storage area so as to be arranged successively, read, from the first storage area for each of the rows, the element data having a first attribute, perform a first calculation for the first attribute by using the element data read from the first storage area, read, from the second storage area, the element data included in a column and having the first attribute, perform a second calculation for the first attribute by using the element data read from the second storage area, and perform a calculation process by using a result of the first calculation and a result of the second calculation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing apparatus according to Example 1;

FIG. 2 is a diagram for explaining gene variant;

FIG. 3 is a diagram for explaining a gene variant database;

FIG. 4 is a diagram illustrating an example of a disease table;

FIG. 5 is a diagram for explaining a statistical process relating to an association between the gene variant and diseases;

FIG. 6 is a block diagram of a server;

FIG. 7 is a sequence diagram in a case where a calculation command using data stored in a flash memory is issued;

FIG. 8 is a sequence diagram in a case where the calculation command using data stored in a DRAM is issued;

FIGS. 9A and 9B are flowcharts of a command process by a host interface;

FIG. 10 is a flowchart of a movement process of data; and

FIG. 11 is a configuration diagram of an information processing apparatus according to Example 2.

### DESCRIPTION OF EMBODIMENTS

### Example 1

In a software-defined SSD, in a case where a data aggregation process configuring a matrix such as a database is performed, there are many cases in which data is stored collectively for each column in consideration of efficient data storage. More specifically, one column data is stored for each page of the flash memory. This is because a data attribute is given in a column direction in a case of the data configuring the matrix and the statistical process or the like with respect to data for each column is performed in many cases.

On the other hand, in the case of the data configuring the matrix, since information for integrating a group of data having attributes in a row direction is given, the addition of data is often performed on a row unit. That is, a case of adding data, data of all columns are added.

Therefore, in a case where the data configuring the matrix is collectively stored for each column, in order to perform the addition of data, rewriting occurs in each page. For example, in the gene variant database, since approximately 20 million column data are handled, rewriting in 20 million points are performed in the addition of data. In addition, since the flash memory does not allow the overwriting, a writing process is performed after erasing data in each page. This includes a process of invalidating data of a page having data to be overwritten and newly writing data to another page. Here, an erase unit is several MB in the flash memory. Therefore, in the SSD storing the data configuring the matrix, the rewriting of data of a size obtained by multiplying, for example, several MB by the number of columns is performed, for one data addition. For example, in the case of the gene variant database having 20 million columns, data rewriting of approximately 19 TB is performed for one addition of data. In this manner, in the software-defined SSD, in a case of storing the data configuring the matrix and in the case of data having a large number of columns, there is a possibility that it takes a huge amount of time in the addition of data.

Furthermore, there is a limitation on the number of times of rewriting in the flash memory. For example, in a case of a triple-level cell (TLC) not and (NAND) flash memory, the limitation of the number of times of rewriting is several hundred times. Therefore, in the SSD storing the data configuring the matrix, erasing and writing are performed in each page storing each row every time data is added, the number of times of rewriting is reached immediately and the lifetime of the flash memory comes such that the number of times that data can be added decreases.

Even when a case of a related art in which data is temporally stored in a local memory when writing and reading is used, in a case where the data configuring the matrix is collectively for each column, erasing and writing for each page at the time of data addition are generated. In addition, even when a related art in which an additional error correction code is temporally stored in a volatile memory, in the case where the data configuring the matrix is collectively for each column, the erasing and writing for each page at the time of data addition are generated. Therefore, regardless of which related art is used, it is hard to efficiently perform the use of memory elements such as the reduction of a time demanded for the addition of data with respect to a memory element such as the flash memory and the reduction of the number of times of writing.

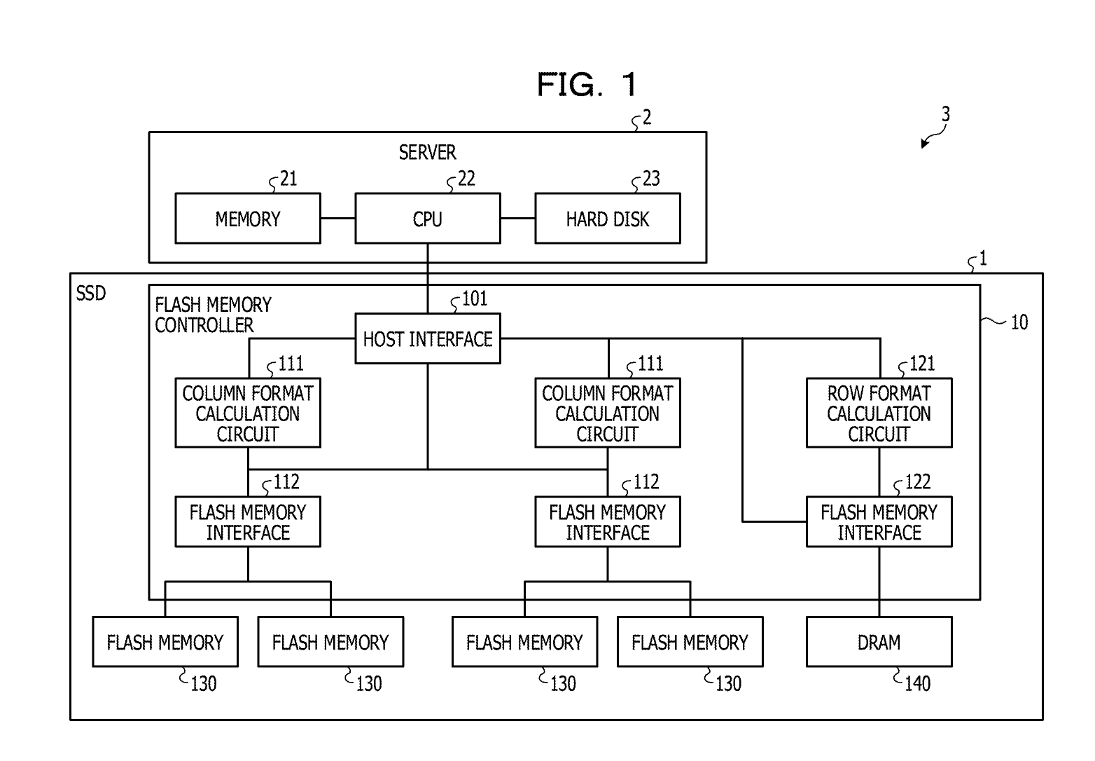

FIG. 1 is a configuration diagram of an information processing apparatus according to Example 1. As illustrated in FIG. 1, an information processing apparatus 3 according to the present example includes an SSD 1 and a server 2. Here, as data to be handled, an example of the data forming the matrix will be described. In addition, here, a set of data of one-row data of the data forming the matrix is called as “row data”. In addition, a set of data one column data is called as “column data”. Each data forming the matrix is an example of “element data”. Furthermore, in the data forming the matrix handled in the present example, data having the same attribute in a column direction are arranged. A row direction indicates a target having each attribute data.

The SSD 1 includes a flash memory controller 10, a flash memory 130, and a DRAM 140.

The flash memory 130 is a NAND flash memory that is a nonvolatile memory element. Although four flash memories 130 are described in FIG. 1, actually the number is not particularly limited. In addition, a flash memory interface 112 and a column format calculation circuit 111 are arranged according to the number of the flash memories 130. The flash memory 130 is the NAND flash memory. The flash memory 130 may not perform an overwriting operation, and in a case of overwriting, existing data is invalidated and new data is written in another area. In addition, in the flash memory 130, reading and writing of data are performed on a page unit of a plurality of bit units. In addition, in the flash memory 130, the erasing of data is performed on a block unit in which a plurality of pages is grouped. The flash memory 130 is an example of a “second memory unit”.

The DRAM 140 is a volatile memory element. Although one DRAM 140 is described in FIG. 1, a plurality of DRAMs 140 may be arranged according to a requested storage amount of data. In addition, a DRAM interface 122 and a row format calculation circuit 121 are arranged according to the number of the DRAMs 140. The DRAM 140 is an example of a “first memory unit”.

The flash memory controller 10 includes a host interface 101, the column format calculation circuit 111, the flash memory interface 112, the row format calculation circuit 121, and the DRAM interface 122.

The host interface 101 is an interface that controls input and output in communication with the server 2. The host interface 101 receives input of a command from a CPU 22 of the server 2. The host interface 101 determines that data stored in the flash memory 130 that is a process target of the input command is data stored in the DRAM 140. Next, the host interface 101 determines whether the input command is a calculation command commanding calculation performance, a read command commanding the reading of data, or a write command commanding the writing of data.

In a case where the input command is to process the data stored in the flash memory 130 as the process target and is the calculation command, the host interface 101 sets a data transmission destination in the column format calculation circuit 111. On the other hand, in a case where the input command is to process the data stored in the flash memory 130 as the process target and is the read command, the host interface 101 sets the data transmission destination in the host interface 101. In addition, since a response in a case of the write command is writing completion notification, the notification destination of the response is the host interface 101, particularly without performing setting of the transmission destination. In the following, in a case where the calculation command, the read command, and the write command are not distinguished, they are referred to as simply “command”. Next, the host interface 101 issues a command to the flash memory interface 112 that manages the flash memory 130 for storing data in which a command is designated as the process target.

Then, in a case of the input command is a read command, the host interface 101 receives data read from the flash memory 130 from the flash memory interface 112. On the other hand, in a case where the input command is the calculation command or the write command, the host interface 101 does not receive input of a response at this time. Next, even in a case of either command, the host interface 101 receives the completion notification from the flash memory interface 112. In a case where the input command is the read command or the write command, the host interface 101 completes a data transmission process.

On the other hand, if the input command is the calculation command, the host interface 101 receives input of calculation result of column format calculation performed by using the data designated by a command from the column format calculation circuit 111. The host interface 101 transmits the acquired calculation result to the CPU 22 of the server 2.

Meanwhile, in a case where the input command is to process the data stored in the DRAM 140 as the process target and is the calculation command, the host interface 101 sets the data transmission destination in the row format calculation circuit 121. On the other hand, in a case where the input command is to process the data stored in the DRAM 140 as the process target and is the read command, the host interface 101 sets the data transmission destination in the host interface 101. Next, the host interface 101 issues a command to the DRAM interface 122.

Then, in a case where the input command is the read command, the host interface 101 receives input of data read from the DRAM 140 from the DRAM interface 122. On the other hand, in a case where the input command is the calculation command or the write command, the host interface 101 does not receive input of the response at this time. Next, even in a case of either command, the host interface 101 receives the completion notification from the flash memory interface 112. In a case where the input command is the read command or the write command, the host interface 101 completes the data transmission process.

On the other hand, if the input command is the calculation command, the host interface 101 receives input of the calculation result of row format calculation performed by using the data designated by a command from the row format calculation circuit 121. The host interface 101 transmits the acquired calculation result to the CPU 22 of the server 2.

A storage destination of process target data by a command can be processed to both the flash memory 130 and the DRAM 140. In this case, the host interface 101 concurrently performs a process in a case where the above-described storage destination of the process target data is the flash memory 130 and the DRAM 140.

In a case where a command issued by the CPU 22 is to process the data stored in the flash memory 130 as the process target and is the calculation command, the column format calculation circuit 111 receives the input of the data designated by a command from the flash memory interface 112. In this case, the column format calculation circuit 111 acquires data stored in the flash memory 130 in a column format. That is, the column format calculation circuit 111 collectively acquires data of one column. The column format calculation circuit 111 performs the column format calculation by using the acquired data. Then, the column format calculation circuit 111 outputs the calculation result of the column format calculation to the host interface 101. The column format calculation circuit 111 is an example of a “second calculation unit”.

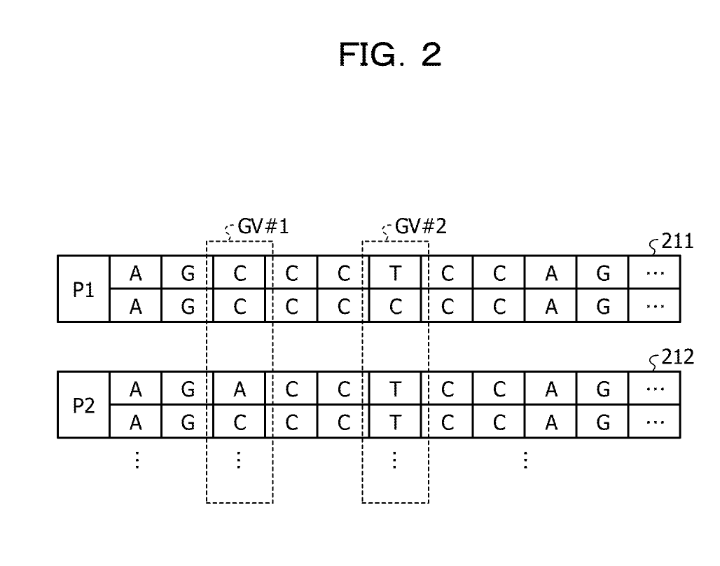

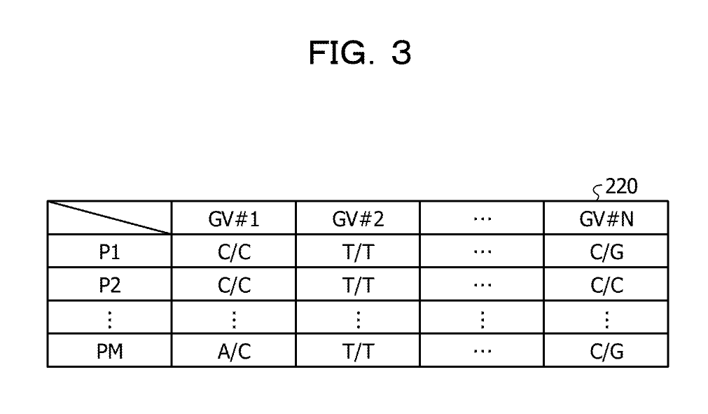

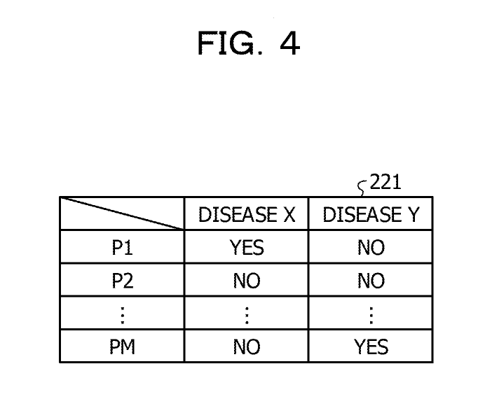

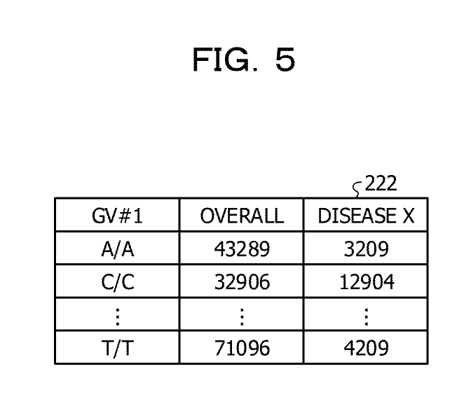

Here, the column format calculation will be described. Here, a case in which data indicating gene variant is stored in the flash memory 130 and the DRAM 140 will be described as an example. FIG. 2 is a diagram for explaining the gene variant. FIG. 3 is a diagram for explaining the gene variant database. FIG. 4 is a diagram illustrating an example of a disease table. FIG. 5 is a diagram for explaining a statistical process relating to a associationship between the gene variant and diseases.

In FIG. 2, information of samples including a genome 211 of a target P1 and a genome 212 of a target P2 is illustrated. The genomes 211 and 212 have a sequence of pairs of bases indicated by A, C, G, and T. In the genomes 211 and 212, for example, there are 20 million points in which the gene variants including gene variants GV#1 and GV#2 occur. By finding an association between the gene variant and the diseases, the information can be used to treat the diseases. In the following, it will be described by using the gene variants GV#1 to GV#N (N=20 million) of 20 million and the targets P1 to PM (M=100,000 for example).

In this case, a database in which data of the gene variants GV#1 to GV#N of each of targets P1 to PM are grouped is indicated by a gene variant database 220 illustrated in FIG. 3. In a case of paying attention to an association between the gene variant and the diseases, it is preferable to specify which gene variant is associated with what kind of disease. Therefore, the number of base pairs present for each gene variant is acquired, and the relevance to the disease is specified. For example, as a disease table 221 illustrated in FIG. 4, there is information on whether or not each of the targets P1 to PM is affected by disease X or Y. In this case, as illustrated in the statistics table 222 illustrated in FIG. 5, by comparing the number of occurrences of each base set included in the gene variant GV#1 with a number suffering from the disease X and having the set of bases, an association between the set of bases and the disease X in the gene variant G1#1 is specified.

Therefore, in order to perform a specifying process of the relevance between the gene variant and the disease, the column format calculation circuit 111 performs the aggregation process of counting the number of occurrences of the set of bases in each of gene variants GV#1 to GV#N. In this case, the column format calculation circuit 111 uses data configuring the gene variant database 220 stored in the flash memory 130. Here, the data configuring the gene variant database 220 in the column format is stored in the flash memory 130. That is, for each of the gene variants GV#1 to GV#N, in other words, for each column of the gene variant database 220, a plurality of pages of the flash memory 130 storing these data are allocated. For example, information of the gene variant GV#1 which is column data of the first column of the gene variant database 220 is stored in a predetermined plurality of pages in the flash memory 130. Since the reading of data from the flash memory 130 is performed on a page unit, the column format calculation circuit 111 acquires the column data of the gene variant database 220, that is, data collectively obtained for each of gene variant GVs#1 to #N from the flash memory interface 112. Therefore, the column format calculation circuit 111 can obtain the number of occurrences of each of the set of bases in each of the gene variants GV#1 to GV#N by counting each of the set of bases in each acquired column data.

In this manner, by acquiring the column data, calculation in which information relating to the column data is calculated by using data included in the column data is the column format calculation. In a case of performing the column format calculation, since the column format calculation circuit 111 can complete the calculation of the acquired column data without using other column data acquired in other timing, it is possible to rapidly perform a calculation process. The column format calculation is an example of “second calculation”.

The explanation will be described by returning to FIG. 1. The flash memory interface 112 receives a command that data stored in the flash memory 130 is the process target from the host interface 101. In a case of the write command, the flash memory interface 112 writes the data designated by a command in the flash memory 130. Then, the flash memory interface 112 outputs the completion notification of data writing to the host interface 101.

Meanwhile, in a case of the read command, the flash memory interface 112 reads the data designated by a command from the flash memory 130. Next, the flash memory interface 112 checks that the data transmission destination set in a command is the host interface 101. The flash memory interface 112 transmits the read data to the host interface 101. Then, the flash memory interface 112 outputs the completion notification of data reading to the host interface 101 when all the reading of the designated data is completed.

On the other hand, in a case of the calculation command, the flash memory interface 112 reads the data designated by a command from the flash memory 130. The flash memory interface 112 reads data on a page unit from the flash memory 130. For example, in a case of the specifying process of relevance with the disease using the above-described gene variant database 220, the flash memory interface 112 commands the reading of a plurality of the column data of the gene variant database 220. Therefore, the flash memory interface 112 can collectively read the column data by reading data from a page storing each column data.

Next, the flash memory interface 112 checks that the data transmission destination set in a command is the column format calculation circuit 111. The flash memory interface 112 transmits the read data to the column format calculation circuit 111. Then, the flash memory interface 112 outputs the completion notification of the data reading to the host interface 101 when all the reading of the designated data is completed.

In a case where the command issued by the CPU 22 is to process data stored in the DRAM 140 as the process target and is the calculation command, the row format calculation circuit 121 receives the input of the data designated by a command from the DRAM interface 122. In this case, the row format calculation circuit 121 acquires data stored in the DRAM 140 in the row format. That is, the row format calculation circuit 121 sequentially acquires attribute data designated by a command included in each row. The row format calculation circuit 121 performs the row format calculation by using the acquired data. Then, the row format calculation circuit 121 outputs the calculation result of the row format calculation to the host interface 101. The row format calculation circuit 121 is an example of a “first calculation unit”.

Here, as an example of the specifying process of the relevance between the gene variant and the disease illustrated in FIGS. 2 to 5, the row format calculation will be described. In order to perform the specifying process of the relevance between the gene variant and the disease illustrated in FIGS. 2 to 5, the row format calculation circuit 121 performs the aggregation process of counting the number of occurrences of each of the set of bases in each of the gene variants GV#1 to GV#N. In this case, the row format calculation circuit 121 uses the data configuring the gene variant database 220 stored in the DRAM 140. Here, in the DRAM 140, the data configuring the gene variant database 220 is stored in the row format. That is, data is stored in the DRAM 140 in a state where data are aligned for each of the targets P1 to PM, in other words, data are aligned for each row of the gene variant database 220. For example, information of the target P1 which is the row data of the first row of the gene variant database 220 is stored in an address area which is continuous from a specific address of the DRAM 140. Since the reading of data from the DRAM 140 is performed at a designated address, the row format calculation circuit 121 sequentially acquires the row data of the gene variant database 220, that is, data of the gene variants GV#1 to GV#N in each of the targets P1 to PM. Therefore, the row format calculation circuit 121 counts a set of each base in each of the gene variants GV#1 to GV#N, every time the gene variants GV#1 to GV#N included in each column data are acquired. By repeating the counting, the row format calculation circuit 121 can obtain the number of occurrences of the set of each base in each of the gene variants GV#1 to GV#N.

In this manner, calculation calculating information relating to each column data by sequentially acquiring information included in the row data is the row format calculation. In a case of performing the row format calculation, the row format calculation circuit 121 uses data included in other row data acquired at other timing. Therefore, since the row format calculation circuit 121 waits for the acquisition of data included in all the row data stored in the DRAM 140 to complete the calculation, the calculation process becomes more complicated than the column format calculation. The row format calculation is an example of “first calculation”.

The explanation will be described by returning to FIG. 1. The DRAM interface 122 receives input of a command for processing data stored in the DRAM 140 as the process target from the host interface 101. In a case of the write command, the DRAM interface 122 writes the data designated by a command in the DRAM 140. Then, the DRAM interface 122 outputs the completion notification of the data writing to the host interface 101.

Meanwhile, in a case of the read command, the DRAM interface 122 reads the data designated by a command from the DRAM 140. Next, the DRAM interface 122 checks that the data transmission destination set in a command is the host interface 101. The DRAM interface 122 transmits the read data to the host interface 101. Then, the DRAM interface 122 outputs the completion notification of the data reading to the host interface 101 when all the reading of the designated data is completed.

On the other hand, in a case of the calculation command, the DRAM interface 122 reads the data designated by a command from the DRAM 140. The DRAM interface 122 sequentially searches data stored in the DRAM 140 from the beginning, and reads data from the designated address. For example, in a case of the specifying process of the relevance with the disease using the above-described gene variant database 220, the DRAM interface 122 commands the reading of a plurality of column data of the gene variant database 220. Therefore, the DRAM interface 122 specifies and reads data designated from data stored by being arranged for each column data. The DRAM interface 122 completes the reading of all the designated column data by reading data included in all the row data stored in the DRAM 140.

Next, the DRAM interface 122 checks that the data transmission destination set in a command is the row format calculation circuit 121. The DRAM interface 122 transmits the read data to the row format calculation circuit 121 for each reading of data. Then, the DRAM interface 122 outputs the completion notification of the data reading to the host interface 101 when all the reading of the designated data is completed.

As illustrated in FIG. 1, the server 2 includes a memory 21, the CPU 22, and a hard disk 23. The hard disk 23 holds a program, library, or the like of an application. The CPU 22 performs the application by extending and performing a program stored in the hard disk 23 on the memory 21.

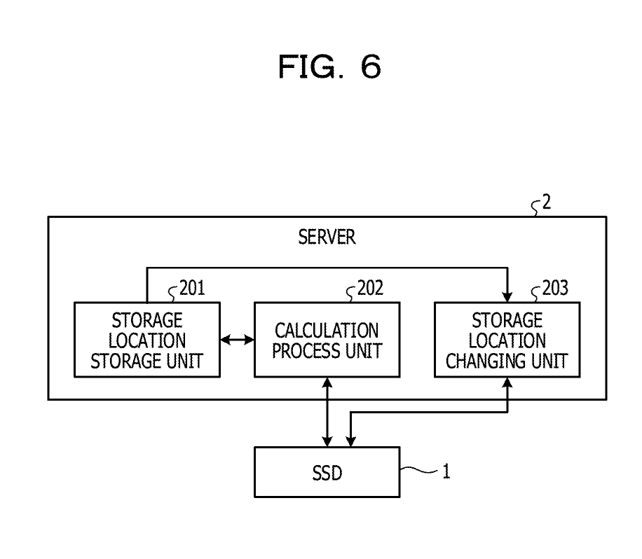

FIG. 6 is a block diagram of a server. The server 2 includes a storage location storage unit 201, a calculation process unit 202, and a storage location changing unit 203. A function of the storage location storage unit 201 is realized by, for example, the memory 21. In addition, the hard disk 23 stores various programs including a program for realizing functions of the calculation process unit 202 and the storage location changing unit 203. The CPU 22 realizes functions of the calculation process unit 202 and the storage location changing unit 203 by reading and performing various programs stored in the hard disk 23. For example, the calculation process unit 202 is realized by an operation of an application performed by the CPU 22.

In a case of the reading of data, the calculation process unit 202 acquires the storage location of the read data from the storage location storage unit 201. The calculation process unit 202 generates the read command commanding the reading of data from the acquired storage location. Next, the calculation process unit 202 issues the generated read command to the SSD 1. Then, the calculation process unit 202 performs the calculation process by using the acquired data.

In a case where near data processing is performed, the calculation process unit 202 acquires the storage location of the read data from the storage location storage unit 201. The calculation process unit 202 generates the calculation command commanding calculation using data read from the acquired storage location. Next, the calculation process unit 202 issues the generated calculation command to the SSD 1. Then, the calculation process unit 202 receives any one of or both the calculation result of the column format calculation and the calculation result of the row format calculation from the SSD 1. The calculation process unit 202 performs the calculation process by using the acquired calculation result.

For example, in an example of the relevance between the gene variant and the disease of the specifying process illustrated in FIGS. 2 to 5, the calculation process by the calculation process unit 202 will be described. Here, a case where the gene variant database 220 is divided into the flash memory 130 and the DRAM 140, and stored in the flash memory 130 and the DRAM 140 will be described. The calculation process unit 202 acquires the number of occurrences of the set of bases for each of the gene variants GV#1 to GV#N calculated by the column format calculation circuit 111 and the number of occurrences of the set of bases for each of the gene variants GV#1 to GV#N calculated by the row format calculation circuit 121.

Next, the calculation process unit 202 calculates the total number of occurrences of the set of bases for each of the gene variants GV#1 to GV#N by adding each calculation result obtained by the column format calculation circuit 111 and the row format calculation circuit 121. With this, the calculation process unit 202 completes the aggregation process in each data of the gene variant database 220.

Here, the calculation process unit 202 has the disease table 221 illustrated in FIG. 4 in advance. The disease table 221 indicates whether or not each of the targets P1 to PM is affected by the disease X or Y. The calculation process unit 202 obtains the number of targets having the set of bases among the targets P1 to PM for each set of bases in each of the gene variants GV#1 to GV#N. Next, the calculation process unit 202 creates a statistics table 222 illustrated in FIG. 5 by associating the total number of occurrences of the set of each base in each of the gene variants GV#1 to GV#N and the number of targets having the set of bases. The calculation process unit 202 determines by the statistical process whether or not there is a significant difference in distribution of the set of each base for each disease in each of the gene variants GV#1 to GV#N. The statistical process may be called as “X2 test” in some cases. The calculation process unit 202 may notify an operator of the information processing apparatus 3 by displaying a determination result as to whether or not there is a significant difference in distribution of the set of each base in each of the gene variants GV#1 to GV#N for each disease on a monitor or the like.

The explanation will be described by returning to FIG. 6. In a case of the writing of data, the calculation process unit 202 determines the storage location of write data. The calculation process unit 202 generates the write command commanding the writing of data with respect to the determined storage location. Next, the calculation process unit 202 issues the generated write command to the SSD 1. Then, the calculation process unit 202 performs the calculation process by using the acquired data. In addition, the calculation process unit 202 registers the storage location of data in the storage location storage unit 201. The calculation process unit 202 is an example of an “overall calculation unit”.

The storage location changing unit 203 monitors a storage state of data registered in the storage location storage unit 201. The storage location changing unit 203 determines whether or not the number of the row data stored in the DRAM 140 exceeds a threshold from the storage location of each data. As the threshold, for example, a value considered to exceed the capacity of the DRAM 140 is set in a case where data is further added.

In a case where the number of the row data stored in the DRAM 140 exceeds the threshold, the storage location changing unit 203 issues a reading command commanding the reading of the total data stored in the DRAM 140 to the SSD 1. Then, the storage location changing unit 203 acquires data stored in the DRAM 140 in the row format. Specifically, the storage location changing unit 203 acquires data in the row format in which data included in each row data forming the matrix are sequentially arranged for each row data.

Next, the storage location changing unit 203 converts the acquired data of the row format into data of the column format. For example, the storage location changing unit 203 generates data of the column format by sequentially arranging the data included in each row for each attribute. The storage location changing unit 203 generates the write command for adding data to data forming existing matrix of the flash memory 130, that is, the write command for collectively storing each column data of the data forming the matrix to be added in a predetermined page. Then, the storage location changing unit 203 issues the generated write command and the data converted into the column format to the SSD 1.

The storage location changing unit 203 registers the storage location of the data converted into the column format in the storage location storage unit 201. Furthermore, the storage location changing unit 203 commands the DRAM 140 to cause the erasing of the moved data. The storage location changing unit 203 is an example of a “storage management unit”.

Here, in the present example, in a case where the number of the row data stored in the DRAM 140 exceeds the threshold, the storage location changing unit 203 performs movement of data to the flash memory 130. However, other conditions may be used for a timing of transferring data from the DRAM 140 to the flash memory 130. For example, in a case where the capacity of the data stored in the DRAM 140 exceeds a predetermined value, the storage location changing unit 203 may perform movement of data to the flash memory 130.

In addition, for example, the storage location changing unit 203 measures calculation times of the column format calculation circuit 111 and the row format calculation circuit 121, and in a case where the calculation time of the row format calculation circuit 121 is longer than the calculation time of the column format calculation circuit 111, the movement of data may be performed. In addition, in a case where the capacity of the data stored in the DRAM 140 exceeds one page of the flash memory 130, the storage location changing unit 203 may perform the movement of data. For example, in the gene variant database 220, data for each of the targets P1 to PM is two bits. In a case where a page size of the flash memory 130 is 16 KiB, the storage location changing unit 203 performs the movement of data when the row data of 65,536 are accumulated in the DRAM 140. Furthermore, the storage location changing unit 203 may use a condition obtained by combining a plurality of conditions for a condition of the movement performance as the movement performance of data.

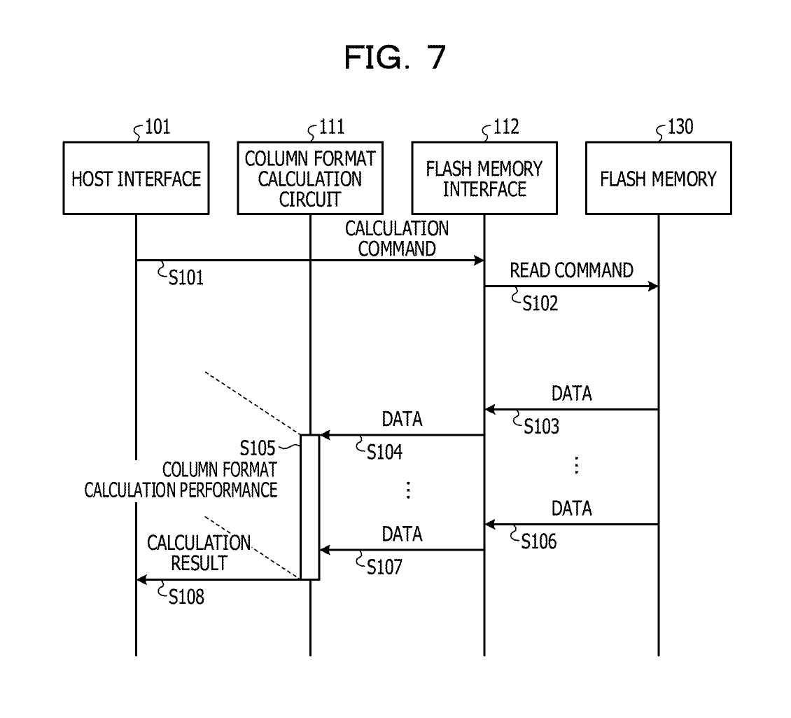

Next, with reference to FIG. 7, a process flow in which the calculation command using the data stored in the flash memory 130 is issued will be described. FIG. 7 is a sequence diagram in a case where the calculation command using data stored in the flash memory is issued.

The host interface 101 receives the calculation command from the server 2. The host interface 101 checks that the storage location of the process target the data designated by the calculation command is the flash memory 130. The host interface 101 outputs the calculation command to the flash memory interface 112 (step S101).

The flash memory interface 112 receives input of the calculation command from the host interface 101. The flash memory interface 112 generates the read command by changing the calculation command to a command format of the reading of data with respect to the flash memory 130, and outputs the generated result to the flash memory 130 (step S102).

The flash memory 130 receives input of a read command from the flash memory interface 112. The flash memory 130 outputs the data designated by the read command to the flash memory interface 112 (step S103). In this case, the flash memory 130 collectively reads the column data on a page unit and collectively outputs the read column data to the flash memory interface 112. Then, the flash memory 130 sequentially outputs the designated data.

The flash memory interface 112 receives the input of the data from the flash memory 130. The flash memory interface 112 outputs the acquired the data of the column format to the column format calculation circuit 111 (step S104). Then, the flash memory interface 112 sequentially outputs the input of the data from the flash memory 130 to the column format calculation circuit 111.

The column format calculation circuit 111 receives the input of the data of the column format from the flash memory interface 112. The column format calculation circuit 111 performs the column format calculation by using the data of the column format. The column format calculation circuit 111 sequentially performs the column format calculation by using the input data of the column format (step S105). In this case, since the column format calculation circuit 111 acquires the column data of a database configuring a matrix, it is possible to complete the column format calculation by counting the data included therein for each type.

The flash memory 130 outputs the last data of the designated data to the flash memory interface 112 (step S106).

The flash memory interface 112 receives input of the last data among the data designated by the read command from the flash memory 130. The flash memory interface 112 outputs the last data to the column format calculation circuit 111 (step S107).

The column format calculation circuit 111 receives the input of the last data from the flash memory interface 112. The column format calculation circuit 111 performs the column format calculation by using the last data, and completes the column format calculation of step S105. Then, the column format calculation circuit 111 outputs the calculation result to the host interface 101 (step S108).

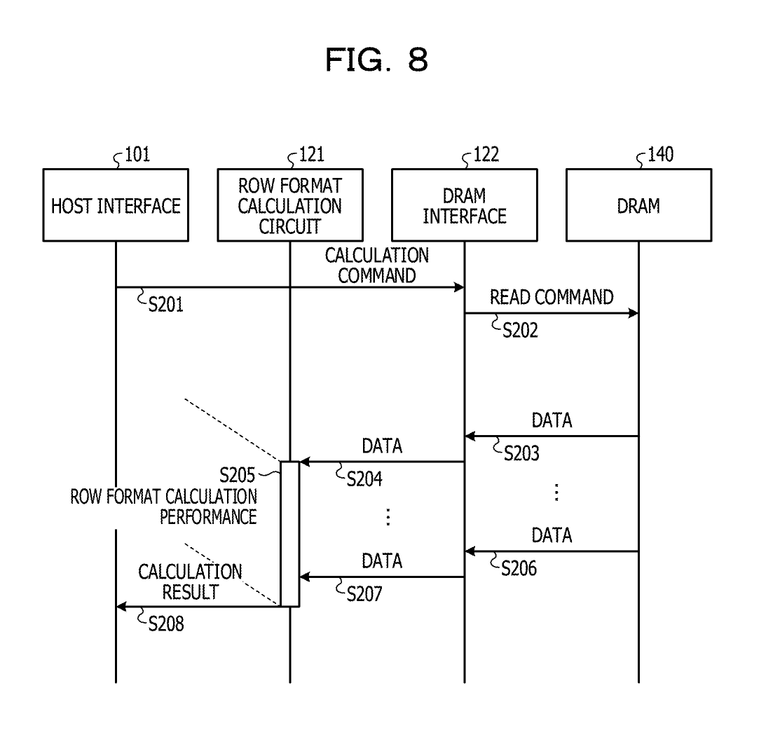

Next, with reference to FIG. 8, a process flow in a case where the calculation command using the data stored in the DRAM 140 is issued, will be described. FIG. 8 is a sequence diagram in a case where the calculation command using data stored in the DRAM is issued.

The host interface 101 receives the calculation command from the server 2. The host interface 101 checks that the storage location of the process target data designated by the calculation command is the DRAM 140. Then, the host interface 101 outputs the calculation command to the DRAM interface 122 (step S201).

The DRAM interface 122 receives input of the calculation command from the host interface 101. The DRAM interface 122 generates the read command by changing the calculation command to a command format of the reading of data with respect to the DRAM 140, and outputs the generated result to the DRAM 140 (step S202).

The DRAM 140 receives input of the read command from the DRAM interface 122. The DRAM 140 outputs the data designated by the read command to the DRAM interface 122 (step S203). In this case, the DRAM 140 reads data by acquiring data an address designated among the data of the row format, and repeats outputting the read data to the DRAM interface 122.

The DRAM interface 122 receives the input of the data from the DRAM 140. The DRAM interface 122 outputs the acquired data to the row format calculation circuit 121 (step S204). Then, the DRAM interface 122 sequentially outputs data input from the DRAM 140 to the row format calculation circuit 121.

The row format calculation circuit 121 receives the input of the data from the DRAM interface 122. The row format calculation circuit 121 performs the row format calculation by using the acquired data (step S205). In this case, since the row format calculation circuit 121 sequentially acquires the row data of the database configuring a matrix, the row format calculation is performed by using the data that are sequentially input.

The DRAM 140 outputs the last data of the designated data to the DRAM interface 122 (step S206).

The DRAM interface 122 receives input of the last data among the data designated by the read command from the DRAM 140. The DRAM interface 122 outputs the last data to the row format calculation circuit 121 (step S207).

The row format calculation circuit 121 receives the input of the last data from the DRAM interface 122. The row format calculation circuit 121 performs the row format calculation by using the last data, and completes the row format calculation of step S205. Then, the row format calculation circuit 121 outputs the calculation result to the host interface 101 (step S208).

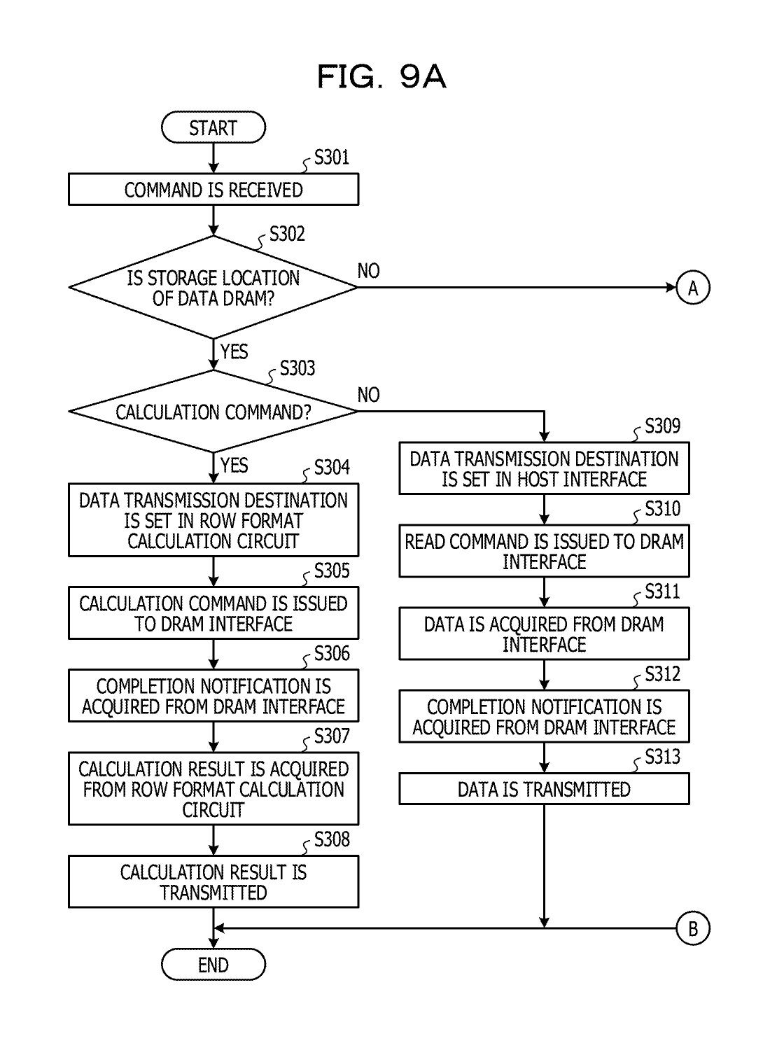

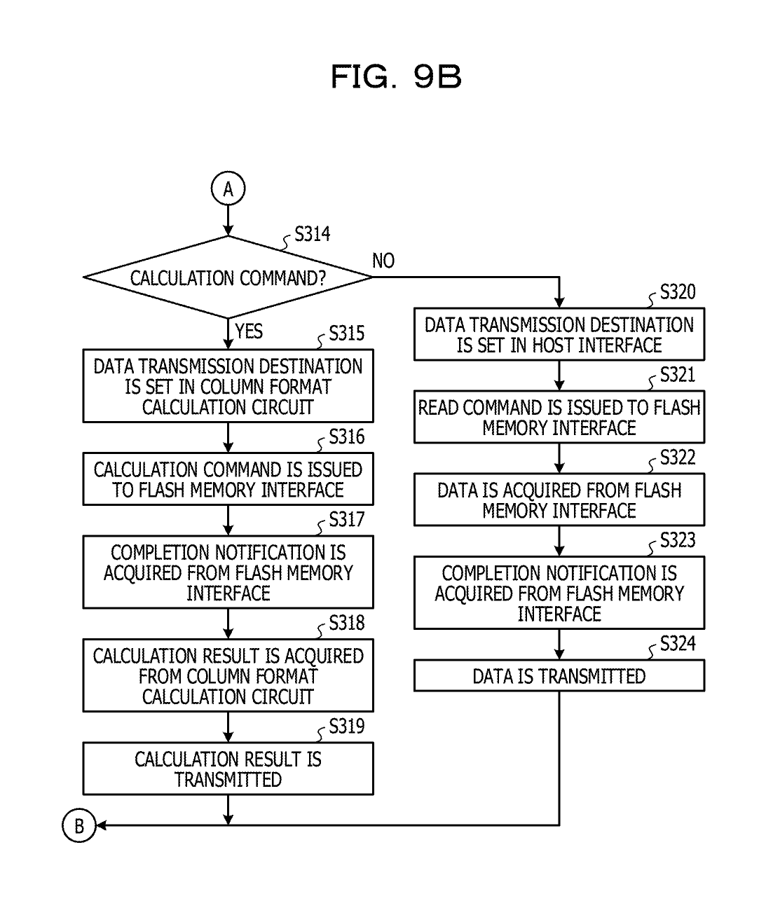

Next, with reference to FIGS. 9A and 9B, flows of a command process by the host interface 101 will be described. FIGS. 9A and 9B are flowcharts of a command process by a host interface. Here, a case where the calculation command or the read command is issued, will be described.

The host interface 101 receives a command from the server 2 (step S301).

Next, the host interface 101 determines whether or not the storage location of data is the DRAM 140 (step S302).

In a case where the storage location of data is the DRAM 140 (step S302: positive), the host interface 101 determines whether or not the command is the calculation command (step S303).

In a case where the command is the calculation command (step S303: positive), the host interface 101 sets the data transmission destination in the row format calculation circuit 121 (step S304).

Next, the host interface 101 issues the calculation command to the DRAM interface 122 (step S305).

Next, the host interface 101 acquires the completion notification of command performance from the DRAM interface 122 (step S306).

Then, the host interface 101 acquires the calculation result of the row format calculation from the row format calculation circuit 121 (step S307).

The host interface 101 transmits the acquired calculation result to the server 2 (step S308).

On the other hand, in a case where the command is not the calculation command, that is, the command is the read command (step S303: negative), the host interface 101 sets the data transmission destination in the host interface 101 (step S309).

Next, the host interface 101 issues the read command to the DRAM interface 122 (step S310).

Next, the host interface 101 acquires the data designated by the read command from the DRAM interface 122 (step S311).

Next, the host interface 101 acquires the completion notification of the command performance from the DRAM interface 122 (step S312).

The host interface 101 transmits the acquired data to the server 2 (step S313).

Meanwhile, in a case where the storage location of data is not the DRAM 140, that is, the storage location is the flash memory 130 (step S302: negative), the host interface 101 determines whether or not the command is the calculation command (step S314).

In a case where the command is the calculation command (step S314: positive), the host interface 101 sets the data transmission destination in the column format calculation circuit 111 (step S315).

Next, the host interface 101 issues the calculation command to the flash memory interface 112 (step S316).

Next, the host interface 101 acquires the completion notification of the command performance from the flash memory interface 112 (step S317).

Then, the host interface 101 acquires the calculation result of the column format calculation from the column format calculation circuit 111 (step S318).

The host interface 101 transmits the acquired calculation result to the server 2 (step S319).

On the other hand, in a case where the command is not the calculation command, that is, the command is the read command (step S314: negative), the host interface 101 sets the data transmission destination in the host interface 101 (step S320).

Next, the host interface 101 issues the read command to the flash memory interface 112 (step S321).

Next, the host interface 101 acquires the data designated by the read command from the flash memory interface 112 (step S322).

Next, the host interface 101 acquires the completion notification of the command performance from the flash memory interface 112 (step S323).

The host interface 101 transmits the acquired data to the server 2 (step S324).

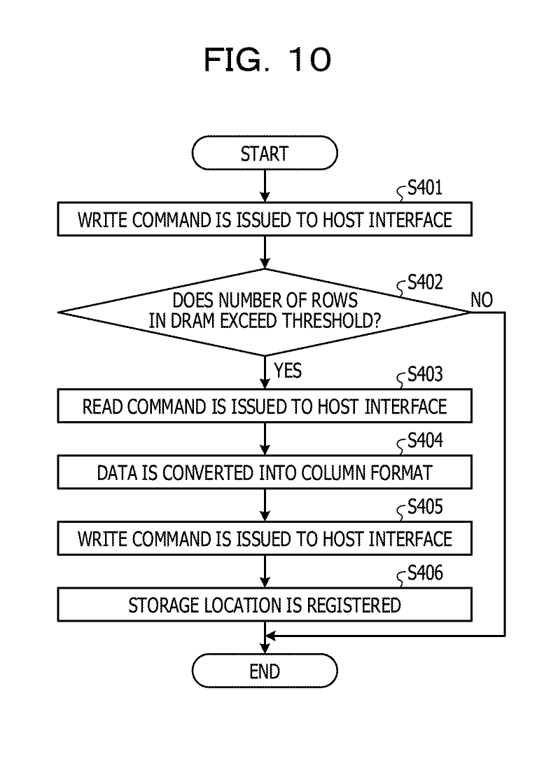

Next, with reference to FIG. 10, a flow of a movement process of data will be described. FIG. 10 is a flowchart of the movement process of data.

The calculation process unit 202 of the server 2 issues the write command to the host interface 101 of the SSD 1 (step S401). At this time, the calculation process unit 202 registers information of the storage location of the data designated by the write command in the storage location storage unit 201.

The storage location changing unit 203 determines whether or not the number of rows in the DRAM 140 exceeds a threshold by using the information of the storage location of each data registered in the storage location storage unit 201 (step S402). In a case where the number of rows in the DRAM 140 does not exceed the threshold (step S402: negative), the storage location changing unit 203 completes the movement process of data.

On the other hand, in a case where the number of rows in the DRAM 140 exceeds the threshold (step S402: positive), the storage location changing unit 203 issues the read command of entire data stored in the DRAM 140 to the host interface 101 of the SSD 1 (step S403).

Then, the storage location changing unit 203 acquires all data of the row format stored in the DRAM 140. The storage location changing unit 203 converts the acquired data of the row format into the data of the column format (step S404).

Next, the storage location changing unit 203 issues a writing command for the flash memory 130 of the data of the column format to the host interface 101 of the SSD 1 (step S405).

Then, the storage location changing unit 203 registers the storage location of data in the flash memory 130 in the storage location storage unit 201 (step S406). Then, the storage location changing unit 203 commands the erasing of data of which movement is completed to the DRAM 140.

Here, in the present example, although the DRAM 140 is used as the memory element storing the data of the row format, other type memory element may be used. For example, a nonvolatile memory such as a magnetoresistive random access memory (MRAM) and a phase change memory (PCM) can be used instead of the DRAM 140.

As described above, in the information processing apparatus according to the present example, in order to write the row data to be added in the DRAM in the row format, the data of DRAM is converted into the column format, and the converted result moves in the flash memory in a case where the data amount of the DRAM satisfies a predetermined condition. In a case of performing the near data processing, the information processing apparatus according to the present example performs the row format calculation with respect to the data stored in the DRAM, and performs the column format calculation with respect to the data stored in the flash memory. With this, it is possible to avoid rewriting of the flash memory that holds each column data for each addition of data, and it is possible to speed up the writing process of data by the addition of data. In addition, since the data immediately after the addition is calculated in the row format, there is a possibility that it may be slower than a case of performing the calculation in the column format. However, since the number of data is small, it is possible to suppress deterioration of the overall performance. In addition, since the number of times of rewriting of the flash memory can be reduced, it is possible to prolong the life of the flash memory. Therefore, it is possible to realize efficient use of the flash memory.

### Example 2

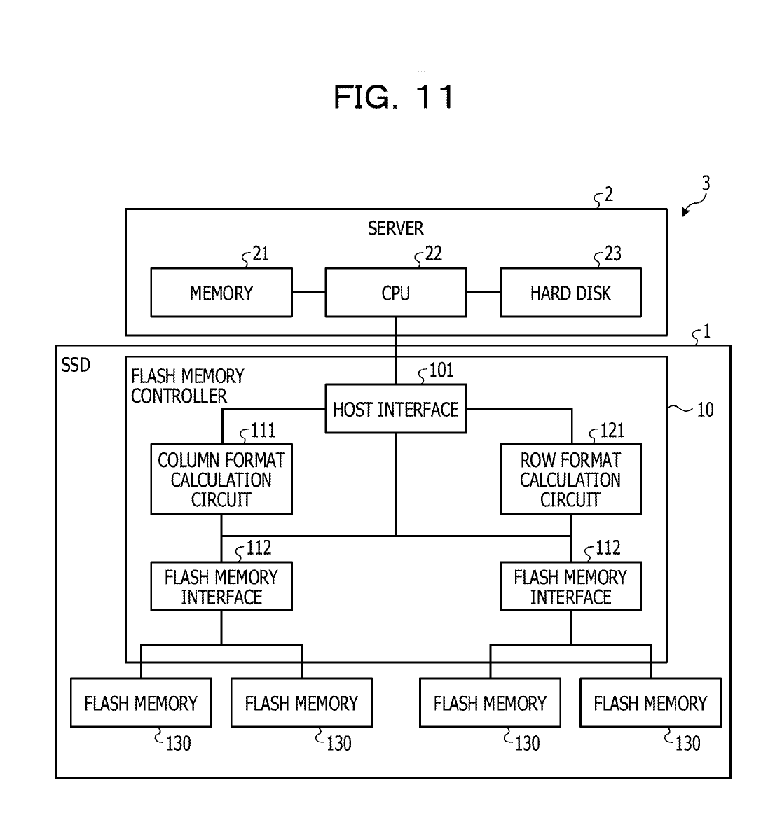

FIG. 11 is a configuration diagram of an information processing apparatus according to Example 2. The information processing apparatus according to the present example 3 is different from that of Example 1 in that the data of the row format is stored in a part of the flash memory 130. The SSD 1 according to the present example has a configuration excluding the DRAM interface 122 and the DRAM 140 illustrated in FIG. 1. In the following description, the description for operations of each unit same as that of Example 1 will be omitted.

In FIG. 11, one column format calculation circuit 111 and one row format calculation circuit 121 are described, but the number is not particularly limited. In addition, paths of the column format calculation circuit 111 and the row format calculation circuit 121 may be separated from each other.

A part of the flash memory 130 allocates a part of a specify area as storage area of the data of the row format in advance.

In a case where input of the calculation command using data stored in a predetermined area of the flash memory 130 is received, the host interface 101 sets the data transmission destination in the row format calculation circuit 121. The host interface 101 outputs the calculation command to the flash memory interface 112.

In a case of adding data, the flash memory interface 112 stores data in a predetermined area of the flash memory 130 in the row format. In addition, in a case where the input of the calculation command using the data stored in a predetermined area of the flash memory 130 is received, the flash memory interface 112 reads data from the predetermined area, and outputs the read data to the row format calculation circuit 121.

In a case where the server 2 issues the calculation command, the row format calculation circuit 121 receives the input of the data stored in the predetermined area of the flash memory 130 in the row format from the flash memory interface 112. The row format calculation circuit 121 performs the row format calculation by using the acquired data of the row format, and outputs the calculation result to the host interface 101.

In a case where the number of the row data stored in the predetermined area of the flash memory 130 exceeds a threshold, the storage location changing unit 203 issues a reading command commanding the reading of all the data stored in the predetermined area of the flash memory 130 to the SSD 1. Then, the storage location changing unit 203 acquires data stored in the predetermined area of the flash memory 130 in the row format.

Next, the storage location changing unit 203 converts the acquired data of the row format into the data of the column format. The storage location changing unit 203 generates the write command for adding the data of the column format to the column data forming a matrix that already presents in the flash memory 130, that is, the write command for collectively storing each column data of the data forming the matrix to be added in a predetermined page. Then, the storage location changing unit 203 issues the generated write command and the data converted into the column format to the SSD 1.

The storage location changing unit 203 registers the storage location of the data converted into the column format in the storage location storage unit 201. Furthermore, the storage location changing unit 203 commands the erasing of data of which movement is completed to the DRAM 140.

As described above, the information processing apparatus according to the present example uses a part of the flash memory as a storage area for the data of the row format. In this manner, by using a part of the flash memory without adding a new DRAM, it is possible to speed up an addition process of data by reducing the number of times of rewriting of the entire flash memory, and it is possible to extend the lifetime of the entire flash memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus configured to control a storage device including a first storage area and a second storage area configured to store element data forming a matrix, the information processing apparatus comprising:
a memory; and
a processor coupled to the memory and configured to:
perform a data storage process for the first storage area in which the element data having mutually different attributes and included in a row of the matrix are arranged successively;
when the data storage process is performed to a plurality of rows respectively and when a state of the element data stored in the first storage area satisfies a certain condition, specify, in the first storage area, a column in which the element data having a same attribute are included;
store the element data included in the column in the second storage area so as to be arranged successively;
read, from the first storage area for each of the rows, the element data having a first attribute;
perform a first calculation for the first attribute by using the element data read from the first storage area;
read, from the second storage area, the element data included in a column and having the first attribute;
perform a second calculation for the first attribute by using the element data read from the second storage area; and
perform a calculation process by using a result of the first calculation and a result of the second calculation.

2. The information processing apparatus according to claim 1, wherein
the processor is configured to integrate the element data stored in the second storage area and the element data read from the first storage area, and store the integrated element data in the second storage area.

3. The information processing apparatus according to claim 1, wherein
the first storage area is included in the second storage area.

4. The information processing apparatus according to claim 1, wherein
the first storage area is a dynamic random access memory (DRAM) and the second storage area is a flash memory.

5. The information processing apparatus according to claim 1, wherein
the certain condition is a threshold set to a data amount of the element data stored in the first storage area.

6. A method executed by an information processing apparatus configured to control a storage device including a first storage area and a second storage area configured to store element data forming a matrix, the method comprising:
performing a data storage process for the first storage area in which the element data having mutually different attributes and included in a row of the matrix are arranged successively;
when the data storage process is performed to a plurality of rows respectively and when a state of the element data stored in the first storage area satisfies a certain condition, specifying, in the first storage area, a column in which the element data having a same attribute are included;
storing the element data included in the column in the second storage area so as to be arranged successively;
reading, from the first storage area for each of the rows, the element data having a first attribute;
performing a first calculation for the first attribute by using the element data read from the first storage area;
reading, from the second storage area, the element data included in a column and having the first attribute;
performing a second calculation for the first attribute by using the element data read from the second storage area; and
performing a calculation process by using a result of the first calculation and a result of the second calculation.

7. The method according to claim 6, further comprising:
integrating the element data stored in the second storage area and the element data read from the first storage area; and
storing the integrated element data in the second storage area.

8. The method according to claim 6, wherein
the first storage area is included in the second storage area.

9. The method according to claim 6, wherein
the first storage area is a dynamic random access memory (DRAM) and the second storage area is a flash memory.

10. The method according to claim 6, wherein
the certain condition is a threshold set to a data amount of the element data stored in the first storage area.

11. A non-transitory computer-readable storage medium storing a program that causes an information processing apparatus to execute a process, the information processing apparatus configured to control a storage device including a first storage area and a second storage area configured to store element data forming a matrix, the process comprising:
performing a data storage process for the first storage area in which the element data having mutually different attributes and included in a row of the matrix are arranged successively;
when the data storage process is performed to a plurality of rows respectively and when a state of the element data stored in the first storage area satisfies a certain condition, specifying, in the first storage area, a column in which the element data having a same attribute are included;
storing the element data included in the column in the second storage area so as to be arranged successively;
reading, from the first storage area for each of the rows, the element data having a first attribute;
performing a first calculation for the first attribute by using the element data read from the first storage area;
reading, from the second storage area, the element data included in a column and having the first attribute;
performing a second calculation for the first attribute by using the element data read from the second storage area; and
performing a calculation process by using a result of the first calculation and a result of the second calculation.

12. The non-transitory computer-readable storage medium according to claim 11, the process further comprising:
integrating the element data stored in the second storage area and the element data read from the first storage area; and
storing the integrated element data in the second storage area.

13. The non-transitory computer-readable storage medium according to claim 11, wherein
the first storage area is included in the second storage area.

14. The non-transitory computer-readable storage medium according to claim 11, wherein
the first storage area is a dynamic random access memory (DRAM) and the second storage area is a flash memory.

15. The non-transitory computer-readable storage medium according to claim 11, wherein
the certain condition is a threshold set to a data amount of the element data stored in the first storage area.
